(19) United States
(12) Patent Application Publication
(10) Pub. No.: US 2024/0300803 A1
(43) Pub. Date: Sep. 12, 2024

(54) FILL NOZZLE

(71) Applicant: Emergency Vehicle Center & American Fire Equipment, Inc., Bronson, IA (US)

(72) Inventor: Craig D. Hillinger, Bronson, IA (US)

(21) Appl. No.: 18/601,072

(22) Filed: Mar. 11, 2024

Related U.S. Application Data
(60) Provisional application No. 63/489,490, filed on Mar. 10, 2023.

(51) Int. Cl. B67D 7/42

(52) U.S. Cl. CPC B67D 7/42

(57) ABSTRACT

A fill nozzle is provided. An angled tube having a first end and a second end wherein a valve is connected at its first end, and its second end serves as the spray end of the fill nozzle. The valve has a fire hose connection connected to it wherein the fire hose connection has a first end capable of connection to a fire hose and a second end connected to the valve. The shape of the angled tube allows a single firefighter to place the spray end in a tank, open the valve, and fill the tank from ground level.

### CROSS-REFERENCE TO RELATED APPLICATIONS

This patent application claims priority to U.S. Provisional Patent Application No. 63/489,490 filed on Mar. 10, 2023, the entirety of which is incorporated herein fully by reference.

### FIELD OF THE DISCLOSURE

This disclosure relates generally to nozzle devices, and in particular to a new fill nozzle device for directing fluid into a tank.

### BACKGROUND OF THE DISCLOSURE

When there is a brush fire or a grassland fire, firefighters use a grassland fire truck to drive into the area to put out the fire. A grassland fire truck is usually a standard pickup truck with a water tank and pump in the bed of the truck. Currently, the typical process for firefighters to fill the water tank in the bed of the grassland fire truck is burdensome and dangerous as water will need to be pumped from the large tanker firetruck and deposited into the water tank in the bed of the grassland fire truck. When filling the tank of the grassland fire truck, utilizing the tank fill tower of the grassland firetruck, one firefighter typically climbs into the bed of the grassland fire truck and then stands in the bed of the grassland fire truck holding a conventional water nozzle or an open hose into the water tank. The firefighter signals or raises his or her arms up and down in order to communicate with a firefighter standing next to the tanker firetruck to start the flow of water. Once the water tank in the grassland firetruck is full, then the firefighter in the bed of the truck will need to communicate with the firefighter operating the tanker firetruck by raising his or her arms up and down in order to signal to the firefighter operating the tanker firetruck to shut the water off. If the firefighter at the tanker firetruck does not immediately notice the signaling of the firefighter in the grassland fire truck, the water may not be shut off in a timely manner and the water tank in the bed of the grassland fire truck can overflow causing potential safety hazards and wasting water resources.

For the reasons stated above, and for other reasons which will become apparent to those skilled in the art upon reading and understanding the specification, there is a need in the art for a fill nozzle that can be operated by a single firefighter to fill a tank from the ground.

These and other objects, features, or advantages of the present disclosure will become apparent from the specification and claims.

### BRIEF SUMMARY OF THE DISCLOSURE

The disclosure relates to a fill nozzle. In one arrangement, a fill nozzle comprises an angled tube having a first end attached to a fire hose via a valve and a second end that serves as the spray end. A handle at the first end provides a secure grip for a firefighter using the fill nozzle.

### BRIEF DESCRIPTION OF THE DRAWINGS

FIG. 1 depicts a fill nozzle according to one embodiment.

FIG. 2 depicts an angled tube of a fill nozzle according to one embodiment.

FIG. 3 depicts a section of an angled tube of a fill nozzle according to one embodiment.

FIG. 4 depicts a section of an angled tube of a fill nozzle according to one embodiment.

FIG. 5 depicts a section of an angled tube of a fill nozzle according to one embodiment.

FIG. 6 depicts a section of an angled tube of a fill nozzle according to one embodiment.

FIG. 7 depicts apertures of a fill nozzle according to one embodiment.

FIG. 8 depicts apertures of a fill nozzle according to one embodiment.

FIG. 9 depicts apertures of a fill nozzle according to one embodiment.

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description and are not intended to be used as limitations. Accordingly, orientation of an object or a combination of objects may change without departing from the scope of the disclosure.

A fill nozzle 100 for filling a water tank is disclosed. The fill nozzle 100 allows for one firefighter to connect a hose to a tanker fire truck, then stand on the ground next to the grassland fire truck, place the fill nozzle 100 directly into the water tank in the grassland fire truck, turn on the water with the valve 110 placed on the fill nozzle 100 to start the flow of water, and then turn off the flow of water by using the valve 110. The disclosed fill nozzle 100 has many advantages including improved safety for all of the firefighters, increased efficiency, reduced water waste, prevention of damage and injury that can occur as a result of having the bed of the grassland fire truck full of water, and other advantages.

### Angled Tube 120

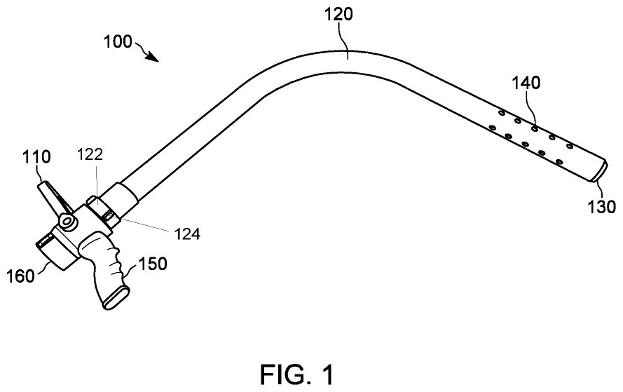

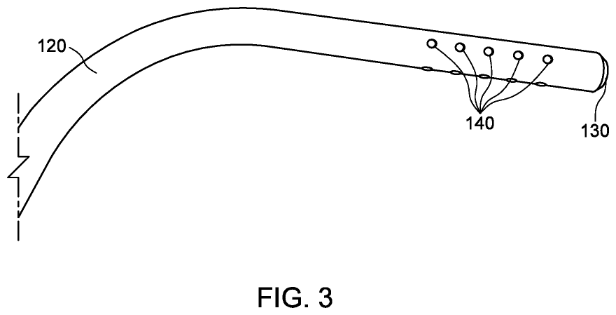

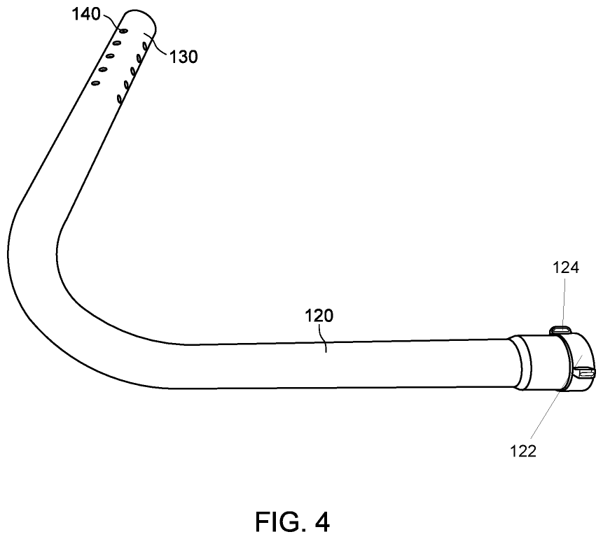

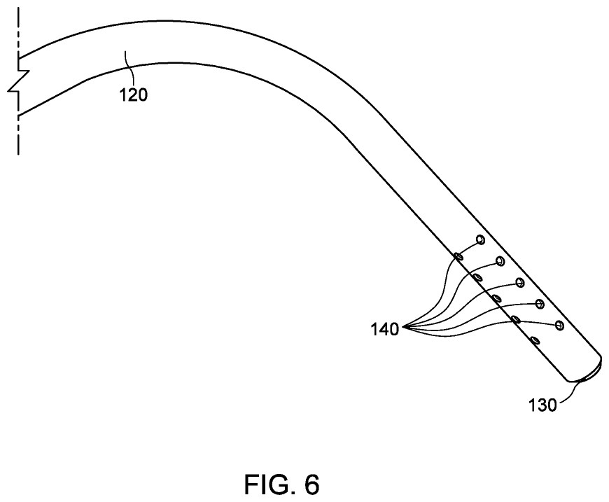

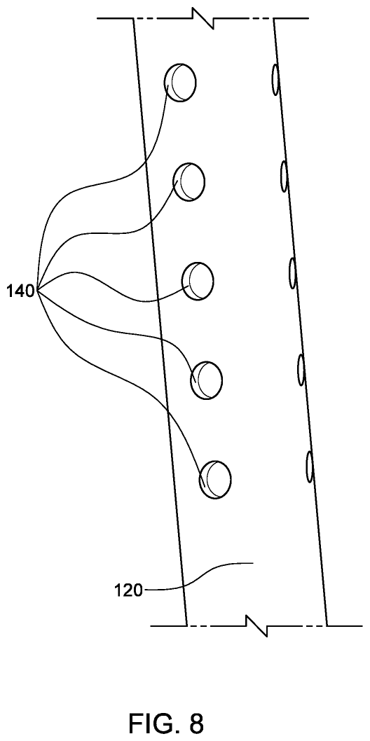

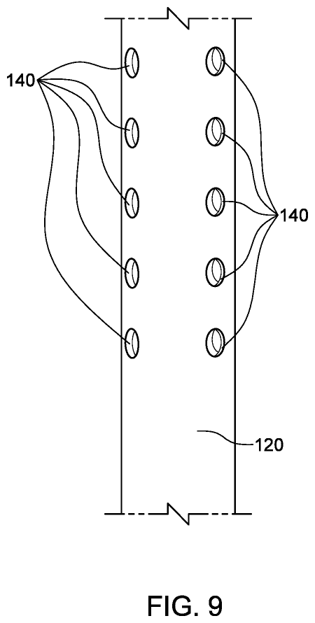

As shown in FIGS. 1-9, a fill nozzle 100 comprises an angled tube 120. Angled tube 120 may be referred to simply as tube 120 without departing from the scope of the disclosure. Angled tube 120 has a first end and a second end that is opposite to the first end. In one embodiment, angled tube 120 comprises a length of tubing that has been bent at the approximate center of angled tube 120.

The first end of the angled tube 120 connects to valve 110 and may include a coupler 122 having a first end, a second end, and a plurality of tabs 124 to facilitate grasping and rotating the angled tube 120 during attachment or detachment to the valve 110. The first end of coupler 122 may comprise a threaded connector configured to securely attach the valve 110 to the angled tube 120. The second end of coupler 122 may be welded or threaded onto the first end of the angled tube 120. The coupler 122 may be hard-coat anodized to meet NFPA standards. In operation, coupler 122 prevents the valve 110 from disconnecting from the angled tube 120 as high pressure fluid moves between connected elements. In one embodiment, coupler 122 may be machined from 6061 extruded aluminum. In other embodiments, coupler 122 may be formed from another suitable material without departing from the scope of the disclosure.

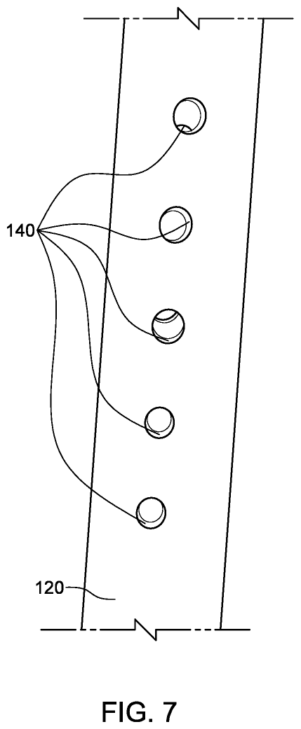

The second end of the angled tube 120 is the spray end 130, which is open such that fluid can be expelled through the spray end 130. As shown in FIGS. 7-9, each of a plurality of apertures 140 extends through the angled tube 120. The plurality of apertures 140 is radially arranged around the angled tube 120 and oriented to expel fluid from the angled tube 120 perpendicular to a longitudinal axis of the angled tube 120.

The bend in angled tube 120 allows for the spray end 130 and apertures 140 to be placed into a water tank while a firefighter operating the fill nozzle 100 stands on the ground.

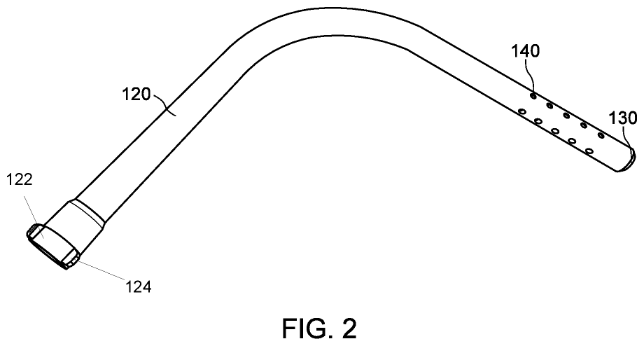

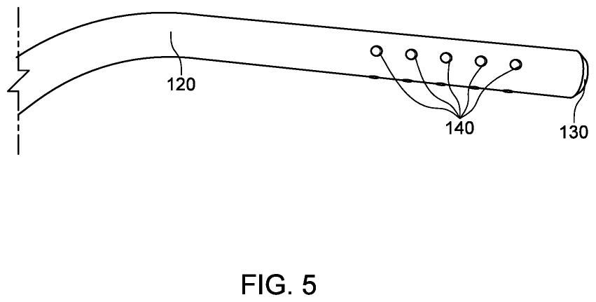

In one arrangement as shown in FIGS. 2-4 and 6, the length of angled tube 120 may be such that a straight line connecting the first end of angled tube 120 to the second end of angled tube 120 measures approximately 40 inches, the length of a line connecting the center point of angled tube 120 and the center point of the straight line connecting the first end of angled tube 120 to the second end of angled tube 120 measures approximately 17.5 inches, the length of the straight portion between the first end and the center of angled tube 120 is approximately 26 inches, and the length of the straight portion between the second end or spray end 130 and the center of angled tube 120 is approximately 26 inches. In another arrangement as shown in FIG. 5, the length of the straight portion between the first end and the center of angled tube 120 is approximately 24 inches, and the length of the straight portion between the second end or spray end 130 and the center of angled tube 120 is approximately 24 inches. However other lengths may be used without departing from the scope of the disclosure.

In one arrangement, angled tube 120 may be formed from a length of extruded structural seamless aluminum tubing such as a 6061 T6 aluminum tube. In other arrangements, angled tube 120 may comprise another metal or another suitable material without departing from the scope of the disclosure. Angled tube 120 may be anodized or hard coat anodized to meet NFPA standards. Angled tube 120 may comprise a 2 inch outer diameter and ⅛ inch thick wall. Alternatively, angled tube 120 may be of any other dimensions without departing from the scope of the disclosure.

### Valve 110

Valve 110 connects to the first end of angled tube 120. When valve 110 is in it its open position, fluid from a hose connected to fill nozzle 100 is allowed to flow through valve 110 and then through angled tube 120. When valve 110 is in its closed position, fluid is prevented from flowing through valve 110 and into angled tube 120. A valve handle coupled to valve 110 allows valve 110 to be moved between the open and closed positions of valve 110.

### Handle 150

A handle 150 attaches to fill nozzle 100 at a point on or near the first end of the angled tube 120 and valve 110. Handle 150 provides a sturdy handgrip allowing a firefighter operating fill nozzle 100 to hold onto fill nozzle 100 during operation. Handle 150 may be constructed from plastic, metal, or any other suitable material.

### Fire Hose Connection 160

Connected to valve 110 is a fire hose connection 160 having a first end and a second end. The first end of fire hose connection 160 may comprise a threaded connector configured to securely attach a fire hose to fill nozzle 100. The second end of fire hose connection 160 may be welded, swiveled, or threaded onto valve 110.

Fire hose connection 160 may be hard-coat anodized to meet NFPA standards.

Fire hose connection 160 may comprise a standard 1.5 inch NH hose couplers. In operation, fire hose connection 160 prevents fill nozzle 100 from disconnecting from the fire hose as high-pressure fluid moves between connected elements.

In one embodiment, fire hose connection 160 may be machined from 6061 extruded aluminum. In other embodiments, fire hose connection 160 may be formed from another suitable material without departing from the scope of the disclosure.

### Operation of Fill Nozzle 100

In one arrangement, fill nozzle 100 may be used to fill a tank of a grassland fire truck by a single firefighter standing on the ground. In such arrangements, a first end of a fire hose is connected to a source of water such as a tanker truck, and the second end of the fire hose is connected to the fire hose connection 160 of fill nozzle 100. Once assembled, valve 110 on the fill nozzle 100 is placed in its closed position, a valve on the tanker truck may be opened, and the firefighter tasked with filling the tank on the grassland fire truck approaches the grassland fire truck. Water flows through the fire hose but is stopped by the valve 110 of fill nozzle 100. When the firefighter reaches the grassland fire truck, the spray end 130 and apertures 140 are placed into the water tank, and the firefighter holds the handle 150 and opens valve 110, allowing water to flow through valve 110 and angled tube 120 into the water tank.

Through use of fill nozzle 100, fire crews may more easily and more safely fill water tanks while fighting grassland fires.

The fill nozzle 100 has many benefits and advantages including, but not limited to improved safety for all of the firefighters, increased efficiency, reduced water waste, and prevention of damage and injury that can occur as a result of having the bed of the grassland fire truck full of water. These and other benefits and advantages of the fill nozzle 100 are apparent from the specification and claims.

### REFERENCE NUMERALS

100—Fill nozzle
110—Valve
120—Angled tube or tube
122—Coupler
124—Plurality of tabs
130—Spray end
140—Apertures
150—Handle
160—Fire hose connection

What is claimed:

1. A fill nozzle comprising:
An angled tube having a first end and a second end;
a valve connected to the first end of the angled tube;
a fire hose connection having a first end and a second end, wherein the first end of the fire hose connection is configured to connect to a fire hose, and the second end of the fire hose connection is connected to the valve; and
wherein the second end of the angled tube is configured to expel fluid.

2. The fill nozzle of claim 1 wherein the second end of the angled tube further comprises a plurality of apertures configured to expel fluid.

3. The fill nozzle of claim 1 further comprising a handle attached to the first end of the angled tube.
